(19) United States
(12) Patent Application Publication
(10) Pub. No.: US 2026/0163183 A1
(43) Pub. Date: Jun. 11, 2026

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sam Jin PARK, Suwon-si (KR); Bich Nam JEONG, Suwon-si (KR); Woo Sung LEE, Suwon-si (KR)

(73) Assignee: SAMSUNG SDI CO., LTD., Yongin-si (KR)

(21) Appl. No.: 19/414,778

(22) Filed: Dec. 10, 2025

(30) Foreign Application Priority Data
Dec. 11, 2024 (KR) 10-2024-0183722

(51) Int. Cl. H01M 50/457; H01M 10/052; H01M 50/42; H01M 50/426; H01M 50/443; H01M 50/46; H01M 50/491

(52) U.S. Cl. CPC H01M 50/457; H01M 50/42; H01M 50/426; H01M 50/443; H01M 50/461; H01M 50/491; H01M 10/052

(57) ABSTRACT

The present disclosure relates to a separator for a rechargeable lithium battery, and a rechargeable lithium battery including the separator. The separator for a rechargeable lithium battery includes a porous substrate, and a first layer and a second layer located on at least one surface of the porous substrate. The first layer includes a composition including a binder, a crosslinking agent, and a filler, the second layer includes a composition including a mixture of a polyvinylidene fluoride (PVdF)-based adhesive binder and a (meth)acrylic adhesive binder, and the (meth)acrylic adhesive binder is crosslinked to the binder of the first layer.

### CROSS-REFERENCE TO RELATED APPLICATION

The present application claims priority to Korean Patent Application No. 10-2024-0183722, filed on Dec. 11, 2024, in the Korean Intellectual Property Office, the entire disclosure of which is incorporated herein by reference.

### BACKGROUND

### 1. Field of the Disclosure

The present disclosure relates to a separator for a rechargeable lithium battery, and a rechargeable lithium battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

The rechargeable lithium battery may include a separator between the positive electrode and the negative electrode. The separator is impregnated in an electrolyte solution. It may be desirable for the separator to maintain the original shape thereof without undergoing thermal shrinkage in the electrolyte to improve or ensure the safety of the battery.

### SUMMARY

One example embodiment includes a separator for a rechargeable lithium battery which provides a high substrate binding force, high dry adhesion to a positive electrode, and high wet adhesion to a positive electrode.

Another example embodiment includes a separator for a rechargeable lithium battery which includes a first layer and a second layer stacked on a porous substrate, and provides a high interface binding force between the first layer and the second layer.

Still another example embodiment includes a rechargeable lithium battery including the separator for a rechargeable lithium battery.

One example embodiment includes a separator for a rechargeable lithium battery.

The separator for a rechargeable lithium battery includes a porous substrate, and a first layer and a second layer located, e.g., sequentially located, on at least one surface of the porous substrate. The first layer is formed of or include a composition including a binder, a crosslinking agent, and a filler, the second layer is formed of or include a composition including a mixture of a polyvinylidene fluoride (PVdF)-based adhesive binder and a (meth)acrylic adhesive binder, and the (meth)acrylic adhesive binder is crosslinked to the binder of the first layer.

Another example embodiment includes a rechargeable lithium battery including: the separator for a rechargeable lithium battery, a positive electrode, and a negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view showing a separator for a rechargeable lithium battery according to one example embodiment; and

FIG. 2 to FIG. 5 are cross-sectional views schematically showing rechargeable lithium batteries according to example embodiments.

### DETAILED DESCRIPTION

Hereinafter, example embodiments of the present disclosure are described in detail. However, these embodiments are provided as examples, the present disclosure is not limited thereto, and the present disclosure is only defined by the scope of the claims to be described below.

Unless otherwise specified herein, when a part such as a layer, film, region, plate, and the like, is described as being “on” another part, it includes not only the case where the part is “directly on” the other part but also the case where there is still another part therebetween. Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Here, the term “particle diameter D100” refers to the average particle diameter, which means the diameter of particles with a cumulative volume of 100% by volume in the particle size distribution. The particle size distribution may be measured by methods known to those skilled in the art. For example, the particle size distribution may be measured using a particle size analyzer, a transmission electron micrograph, or a scanning electron micrograph. In another method, an D100 value may be obtained by measuring the particle diameter using a measuring device using, e.g., dynamic light scattering, performing data analysis to count the number of particles for each particle size range, and then calculating the particle diameter therefrom. Alternatively, D100 may be measured using a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D100 based on 100% of the particle diameter distribution in the measurement device may be calculated.

In this specification, ‘particle diameter D50’ refers to the particle diameter of a particle having a cumulative volume of 50% by volume in a particle size distribution. The particle size distribution can be obtained by referring to the method described in the above ‘particle diameter D100’.

In this specification, “(meth)acrylic” means acrylic and/or methacrylic.

Unless otherwise defined herein, “substitution” means that hydrogen in a compound is replaced by a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br or I), a hydroxyl group (—OH), a nitro group (—NO₂), a cyano group (—CN), an amino group (—NRR′) (wherein, R and R′ are each independently hydrogen or a C1 to C6 alkyl group), a sulfobetaine group (—RR′N⁺(CH₂)ₙSO₃⁻, n is a natural number from 1 to 10), a carboxybetaine group (—RR′N⁺(CH₂)ₙCOO⁻, n is a natural number from 1 to 10) (wherein, R and R′ are each independently a C1 to C20 alkyl group), an azido group (—N₃), an amidino group (—C(═NH)NH₂), a hydrazino group (—NHNH₂), a hydrazono group (═N(NH₂), a carbamoyl group (—C(O)NH₂), a thiol group (—SH), an acyl group (—C(═O)R, where R is hydrogen, a C1 to C6 alkyl group, a C1 to C6 alkoxy group, or a C6 to C12 aryl group), a carboxyl group (—COOH) or a salt thereof (—C(═O) OM, where M is an organic or inorganic cation), a sulfonic acid group (—SO₃H) or a salt thereof (—SO₃M, where M is an organic or inorganic cation), a phosphate group (—PO₃H₂) or a salt thereof (—PO₃MH or —PO₃M₂, where M is an organic or inorganic cation), and combinations thereof.

Hereinafter, a C1 to C3 alkyl group means a methyl group, an ethyl group, or a propyl group. A C1 to C10 alkylene group may be or include, for example, a C1 to C6 alkylene group, a C1 to C5 alkylene group, or a C1 to C3 alkylene group, such as a methylene group, an ethylene group, or a propylene group. A C3 to C20 cycloalkylene group may be or include, for example, a C3 to C10 cycloalkylene group or a C5 to C10 cycloalkylene group, such as a cyclohexylene group. A C6 to C20 arylene group may be or include, for example, a C6 to C10 arylene group, such as a phenylene group. A C3 to C20 heterocyclic group may be or include, for example, a C3 to C10 heterocyclic group, such as a pyridine group.

Hereinafter, “hetero” means including one or more heteroatoms such as or including at least one of N, O, S, Si, and P.

In chemical formulas, the * symbol indicates a moiety that is connected to the same or different atoms, groups, or structural units. Unless otherwise specifically stated in the chemical formulas described herein, it may be assumed that hydrogen is bonded in the structure of the chemical formula.

Hereinafter, “alkali metal” refers to an element belonging to Group 1 of the periodic table, such as lithium, sodium, potassium, rubidium, cesium, or francium, and may be present in a cationic or neutral state.

When describing a numerical range in this specification, ‘X to Y’ means ‘X or more and Y or less (X≤ and ≤Y).’

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, a separator for a rechargeable battery of the present disclosure can improve the safety and lifespan of a battery by providing a high substrate binding force, high dry adhesion to a positive electrode, high wet adhesion to a positive electrode, and a high interface binding force between a first layer and a second layer.

According to one example embodiment, in the separator, a substrate binding force may be about 1.1 gf/mm or more. In the above range, the effects of the separator can be improved because a crosslinking agent of the first layer and a (meth)acrylic adhesive binder of the second layer are crosslinked at an interface of the first layer and the second layer.

According to one example embodiment, in the separator, dry adhesion to a positive electrode may be about 0.9 gf/mm or more, and wet adhesion to a positive electrode may be about 0.9 gf/mm or more. Here, the positive electrode may include lithium cobalt oxide as a positive electrode active material.

The separator may include a porous substrate, and a first layer and a second layer located, e.g., sequentially located, on at least one surface of the porous substrate, wherein the first layer is formed of or include a composition including a binder, a crosslinking agent, and a filler, the second layer is formed of or include a composition including a mixture of a polyvinylidene fluoride (PVdF)-based adhesive binder and a (meth)acrylic adhesive binder, and the (meth)acrylic adhesive binder is crosslinked to the binder of the first layer.

The (meth)acrylic adhesive binder is included in the second layer and is crosslinked through the crosslinking agent at an interface of the first layer and the second layer. Therefore, a high interface binding force between the first layer and the second layer can be provided.

According to one example embodiment, the (meth)acrylic adhesive binder may be distributed on the interface of the first layer and the second layer. A method of distributing the (meth)acrylic adhesive binder on the interface of the first layer and the second layer is described in more detail below in a method of manufacturing the separator.

According to one example embodiment, the (meth)acrylic adhesive binder may have a functional group that can undergo a crosslinking reaction with the crosslinking agent. For example, the functional group that can undergo a crosslinking reaction with the crosslinking agent may be or include one or more of an amine group, a hydroxyl group, a carboxylic group, an amide group, and a cyano group. A method of crosslinking the (meth)acrylic adhesive binder and the crosslinking agent is described in more detail below in the method of manufacturing the separator.

Hereinafter, a configuration of the separator according to one example embodiment is described in detail.

### First Layer

The first layer is formed of or include a composition including a binder, a crosslinking agent, and a filler.

According to one example embodiment, the first layer may include a crosslinked product of the composition.

### Binder

The binder is a non-adhesive binder and may contribute to lowering a thermal shrinkage rate of the separator due to having high heat resistance. The binder may be or include a water-based heat-resistant binder.

According to one example embodiment, the binder may include a (meth)acrylic binder. According to one example embodiment, the (meth)acrylic binder may be included in an amount of about 95 wt % or more, for example, in a range of about 95 wt % to about 100 wt %, or 100 wt %, of the binder.

The (meth)acrylic binder includes a (meth)acrylic binder including a sulfonate group-containing structural unit. The (meth)acrylic binder including the sulfonate group-containing structural unit may be favorable for improving heat resistance and reducing membrane resistance when included in a coating layer together with the mixture.

The sulfonate group-containing structural unit may be included in an amount in a range of about 0.1 mol % to about 65 mol %, for example, about 0.1 mol % to about 60 mol %, 0.1 mol % to 20 mol %, 0.1 mol % to 10 mol %, 1 mol % to 20 mol %, 1 mol % to 10 mol %, a range of about 20 mol % to about 65 mol %, or a range of about 30 mol % to about 65 mol %, in the (meth)acrylic binder. When the sulfonate group-containing structural unit is included in the above range, the (meth)acrylic binder and the separator including the sulfonate group-containing structural unit may exhibit desired or improved adhesiveness, heat resistance, air permeability, and oxidation resistance.

The (meth)acrylic binder may further include one or more of a structural unit derived from (meth)acrylate or (meth)acrylic acid, a cyano group-containing structural unit, and a structural unit derived from (meth)acrylamide.

The structural unit derived from (meth)acrylate or (meth)acrylic acid may be included in an amount in a range of about 0 mol % to about 70 mol %, for example, 10 mol % to 70 mol %, 10 mol % to 60 mol %, 20 mol % to 60 mol %, 10 mol % to 50 mol %, 30 mol % to 60 mol %, 10 mol % to 40 mol %, or 40 mol % to 55 mol %, in the (meth)acrylic binder. When the structural unit derived from (meth)acrylate or (meth)acrylic acid is included in the above range, the separator including the (meth)acrylic binder may exhibit a desired or improved adhesiveness, heat resistance, air permeability, and oxidation resistance.

The cyano group-containing structural unit may be included in an amount in a range of about 0 mol % to about 85 mol %, for example, 30 mol % to 85 mol %, for example, 30 mol % to 70 mol %, for example, 30 mol % to 60 mol %, for example, 35 mol % to 60 mol %, or 35 mol % to 55 mol %, in the (meth)acrylic binder. When the cyano group-containing structural unit is included in the above range, the (meth)acrylic binder and the separator including the cyano group-containing structural unit may secure desired or improved oxidation resistance and may exhibit desired or improved adhesiveness, heat resistance, and air permeability.

The structural unit derived from (meth)acrylamide may be included in an amount in a range of about 0 mol % to about 95 mol %, for example, 40 mol % to 85 mol %, for example, 50 mol % to 85 mol %, 55 mol % to 95 mol %, 60 mol % to 85 mol %, 75 mol % to 95 mol %, or 80 mol % to 95 mol %, in the (meth)acrylic binder. When the structural unit derived from (meth)acrylamide is included in the above range, the (meth)acrylic binder and the separator including the structural unit derived from (meth)acrylamide may secure desired or improved oxidation resistance and may exhibit desired or improved adhesiveness, heat resistance, and air permeability.

According to one example embodiment, the (meth)acrylic binder may have a sulfonate group-containing structural unit, a structural unit derived from (meth)acrylate or (meth)acrylic acid, and a cyano group-containing structural unit (referred to as a first binder). In one example embodiment, the sum of the content of the sulfonate group-containing structural unit, the structural unit derived from (meth)acrylate or (meth)acrylic acid, and the cyano group-containing structural unit may be about 95 mol % or more, for example, in a range of about 95 mol % to about 100 mol %, or about 100 mol %, based on 100 mol % of the (meth)acrylic binder.

According to another example embodiment, the (meth)acrylic binder may have a sulfonate group-containing structural unit and a structural unit derived from (meth)acrylamide (referred to as a second binder). In one example embodiment, the sum of the content of the sulfonate group-containing structural unit and the structural unit derived from (meth)acrylamide may be about 95 mol % or more, for example, in a range of about 95 mol % to about 100 mol %, or 100 mol %, based on 100 mol % of the (meth)acrylic binder.

According to still another example embodiment, the (meth)acrylic binder may have a sulfonate group-containing structural unit, a structural unit derived from (meth)acrylate or (meth)acrylic acid, and a structural unit derived from (meth)acrylamide (referred to as a third binder). In one example embodiment, the sum of the content of the sulfonate group-containing structural unit, the structural unit derived from (meth)acrylate or (meth)acrylic acid, and the structural unit derived from (meth)acrylamide may be about 95 mol % or more, for example, in a range of about 95 mol % to about 100 mol %, or 100 mol %, based on 100 mol % of the (meth)acrylic binder.

For example, the (meth)acrylic binder may be the second binder or the third binder. The second binder or the third binder may have a better membrane resistance reducing effect and a better heat resistance improving effect.

Each structural unit of the (meth)acrylic binder is described in detail.

The structural unit derived from (meth)acrylate or (meth)acrylic acid may be, for example, represented by at least one of the following Chemical Formula 1, Chemical Formula 2, Chemical Formula 3, or a combination thereof:

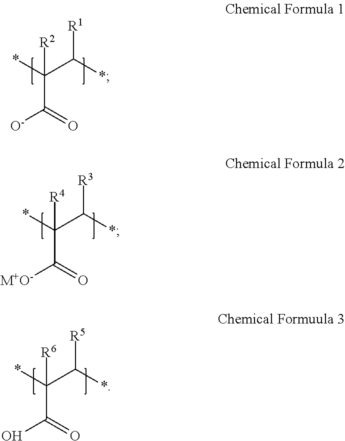

### In Chemical Formulas 1 to 3 Above,

R¹ to R⁶ each independently is or includes hydrogen or a methyl group, and in Chemical Formula 2,
M is or includes an alkali metal.

The alkali metal may be or include, for example, at least one of lithium, sodium, potassium, rubidium, or cesium.

For example, the structural unit derived from (meth)acrylate or (meth)acrylic acid may include the structural unit represented by Chemical Formula 2 and the structural unit represented by Chemical Formula 3, in which case the structural unit represented by Chemical Formula 2 and the structural unit represented by Chemical Formula 3 may be included in a molar ratio in a range of about 10:1 to about 1:2, 10:1 to 1:1, or 5:1 to 1:1.

The cyano group-containing structural unit may be, for example, represented by the following Chemical Formula 4:

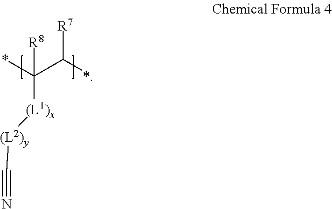

### In Chemical Formula 4 Above,

R⁷ and R⁸ each independently is or includes hydrogen or a C1 to C3 alkyl group,
L¹ is or includes —C(═O)—, —C(═O)O—, —OC(═O)—, —O—, or —C(═O) NH—,
x is an integer ranging from 0 to 2,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2.

For example, the cyano group-containing structural unit may be or include a structural unit derived from (meth)acrylonitrile, alkenenitrile, cyanoalkyl (meth)acrylate, or 2-(vinyloxy)alkane nitrile. Here, the alkene may be or include C1 to C20 alkene, C1 to C10 alkene, or C1 to C6 alkene, the alkyl may be C1 to C20 alkyl, C1 to C10 alkyl, or C1 to C6 alkyl, and the alkane may be C1 to C20 alkane, C1 to C10 alkane, or C1 to C6 alkane.

The alkenenitrile may be or include, for example, at least one of allyl cyanide, 4-pentene nitrile, 3-pentene nitrile, 2-pentene nitrile, or 5-hexene nitrile, and the like. The cyanoalkyl(meth)acrylate may be or include, for example, at least one of cyanomethyl(meth)acrylate, cyanoethyl(meth)acrylate, cyanopropyl(meth)acrylate, or cyanooctyl(meth)acrylate. The 2-(vinyloxy)alkanenitrile may be or include, for example, 2-(vinyloxy)ethane nitrile, or 2-(vinyloxy)propane nitrile.

The sulfonate group-containing structural unit may be or include a structural unit containing a conjugate base of a sulfonic acid, a sulfonate salt, a sulfonic acid ester, or a derivative thereof. For example, the sulfonate group-containing structural unit may be represented by at least one of Chemical Formula 5, Chemical Formula 6, Chemical Formula 7, or a combination thereof:

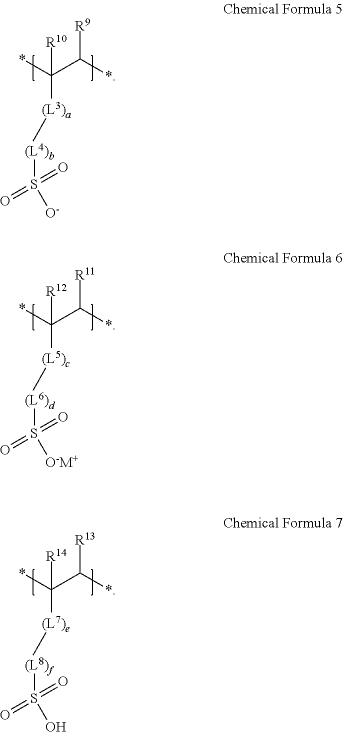

### In Chemical Formulas 5 to 7 Above,

R⁹ to R¹⁴ each independently is or includes hydrogen or a C1 to C3 alkyl group,
L³, L⁵, and L⁷ each independently is or includes —C(═O)—, —C(═O)O—, —OC(═O)—, —O—, or —C(═O) NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and in Chemical Formula 6 above,
M is or includes an alkali metal.

For example, in Chemical Formulas 5 to 7 above,
L³, L⁵, and L⁷ each independently is or includes —C(═O) NH—,
L⁴, L⁶, and L⁸ each independently is or includes a C1 to C10 alkylene group, and
a, b, c, d, e, and f are equal to 1.

The sulfonate group-containing structural unit may include only one of the structural unit represented by Chemical Formula 5, the structural unit represented by Chemical Formula 6, and the structural unit represented by Chemical Formula 7, or two or more thereof. For example, the sulfonate group-containing structural unit may include the structural unit represented by Chemical Formula 6, or in another example, the sulfonate group-containing structural unit may include the structural unit represented by Chemical Formula 6 and the structural unit represented by Chemical Formula 7.

The sulfonate group-containing structural unit may be or include, for example, a structural unit derived from at least one of vinyl sulfonic acid, allyl sulfonic acid, styrene sulfonic acid, anethole sulfonic acid, (meth)acryl amidoalkane sulfonic acid, sulfoalkyl (meth)acrylate, or a salt thereof. Here, the alkane may be C1 to C20 alkane, C1 to C10 alkane, or C1 to C6 alkane and the alkyl may be C1 to C20 alkyl, C1 to C10 alkyl, or C1 to C6 alkyl. The salt refers to a salt consisting of the sulfonic acid and a desired ion. The ion may be or include, for example, an alkali metal ion, and in this case, the salt may be or include an alkali metal sulfonate salt.

The (meth)acryl amidoalkane sulfonic acid may be or include, for example, at least one of 2-(meth)acrylamido-2-methylpropane sulfonic acid, and the sulfoalkyl (meth)acrylate may be or include, for example, 2-sulfoethyl (meth)acrylate, 3-sulfopropyl (meth)acrylate, and the like.

The structural unit derived from (meth)acrylamide may be represented by Chemical Formula 8 below.

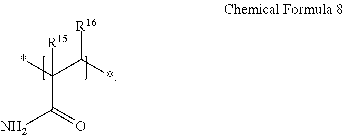

### In Chemical Formula 8 Above,

R¹⁵ and R¹⁶ each independently is or includes hydrogen or a methyl group.

The (meth)acrylic binder may include an alkali metal. The alkali metal may be present in the form of a cation and may be or include, for example, at least one of lithium, sodium, potassium, rubidium, or cesium. For example, the alkali metal may be present in the form of a salt combined with the (meth)acrylic binder. The alkali metal may assist the synthesis of the (meth)acrylic binder in an aqueous solvent, improve the adhesiveness of the coating layer, and improve the heat resistance, air permeability, and oxidation resistance of the separator.

The alkali metal may be included in an amount in a range of about 1 wt % to about 40 wt %, for example, 1 wt % to 30 wt %, 1 wt % to 20 wt %, or 10 wt % to 20 wt % of the alkali metal and the (meth)acrylic binder. For example, the (meth)acrylic binder and the alkali metal may be included in a weight ratio in a range of about 99:1 to about 60:40, a weight ratio of about 99:1 to about 70:30, for example, a weight ratio of about 99:1 to about 80:20, for example, a weight ratio of about 90:10 to about 80:20.

In addition, the alkali metal may be included in an amount in a range of about 0.1 mol % to about 1.0 mol % based on the total content of the alkali metal and the (meth)acrylic binder. When the alkali metal is included within the above range, the coating layer may have desired or improved adhesiveness, and a separator including the coating layer may exhibit desired or improved heat resistance, air permeability, and oxidation resistance.

The (meth)acrylic binder may have various forms, such as an alternating polymer in which the structural units are alternately distributed, a random polymer in which the structural units are randomly distributed, or a graft polymer in which some of the structural units are grafted.

A weight average molecular weight (Mw) of the (meth)acrylic binder may be in a range of about 200,000 g/mol to about 700,000 g/mol, for example, 200,000 g/mol to 600,000 g/mol, for example, 300,000 g/mol to 600,000 g/mol. When the weight average molecular weight of the (meth)acrylic binder satisfies the above range, the (meth)acrylic binder and the separator including the (meth)acrylic binder may exhibit desired or improved adhesiveness, heat resistance, air permeability, and oxidation resistance. The weight average molecular weight may be or include a polystyrene-converted average molecular weight measured using gel permeation chromatography.

The (meth)acrylic binder may have a glass transition temperature in a range of about 200° C. to about 280° C., for example, 210° C. to 270° C., for example, 210° C. to 260° C. When the glass transition temperature of the (meth)acrylic binder satisfies the above range, the (meth)acrylic binder and the separator including the (meth)acrylic binder may exhibit desired or improved adhesiveness, heat resistance, air permeability, and oxidation resistance. The glass transition temperature may be a value measured using differential scanning calorimetry (DSC).

The (meth)acrylic binder may have a melting point (Tm) of about 160° C. or higher.

The (meth)acrylic binder may be prepared by a solution polymerization method.

According to one example embodiment, the (meth)acrylic binder may be included in a film form in the coating layer of the separator.

### Crosslinking Agent

The crosslinking agent may be or include any crosslinking agent that can crosslink the (meth)acrylic binder in the second layer. For example, the crosslinking agent may be or include one or more of a polyfunctional aziridine-based crosslinking agent, a polyfunctional carbodiimide-based crosslinking agent, and citric acid.

In one example embodiment, the crosslinking agent may be citric acid. The citric acid is a compound having a hydroxyl group and a plurality of carboxylic acid groups. Therefore, it may be possible for the citric acid to crosslink the binder in the first layer and the (meth)acrylic adhesive binder in the second layer.

The crosslinking agent, for example, the citric acid, needs to be included in a desired amount with respect to the binder, for example, the (meth)acrylic binder. According to one example embodiment, the crosslinking agent, for example, the citric acid, may be included in an amount in a range of about 5 wt % to about 50 wt %, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 wt %, 10 wt % to 30 wt %, or 10 wt % to 20 wt %, based on the content of the (meth)acrylic binder. In the above range, the dry adhesion and wet adhesion to a positive electrode may be readily improved.

### Filler

The filler may be or include an inorganic filler, an organic filler, an organic/inorganic filler, or a combination thereof. The inorganic filler may be or include a ceramic material capable of improving heat resistance. The inorganic filler may be or include, for example, at least one of a metal oxide, a semi-metal oxide, a metal fluoride, a metal hydroxide, or a combination thereof. The inorganic filler may be or include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include at least one of an acrylic compound, an imide compound, an amide compound, or a combination thereof, but is not limited thereto. The organic filler may have a core-shell structure, but is not limited thereto. For example, the filler may be boehmite.

The filler may be spherical, sheet-shaped, cubic, or amorphous. For example, the filler may be or include a sheet-shaped filler.

The filler needs to be included in a desired amount with respect to the binder, for example, the (meth)acrylic binder. According to one example embodiment, the binder and the filler may be included in a mass ratio in a range of about 1:10 to about 1:50, for example, 1:10, 1:15, 1:20, 1:25, 1:30, 1:35, 1:40, 1:45, 1:50, 1:10 to 1:30 or 1:20 to 1:30. In the above range, there may exhibit an effect of reducing shrinkage in an electrolyte.

The filler may have a particle diameter D100 of about 1.0 μm or less. Within the above range, it may be possible to reach the dry shrinkage rate. For example, the filler may have a particle diameter D100 of about 0.5 μm or less, about 0.8 μm or less, in a range of about 0.5 μm to about 0.8 μm, or 0.5 μm to 0.7 μm.

The filler may have a particle diameter D50 of about 0.4 μm or less, for example, about 0.3 μm or less, for example, a range of about 0.15 μm to about 0.3 μm. In the above range, there may be an effect of reducing shrinkage in an electrolyte.

The filler may be included in an amount in a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, for example, 95 wt % to 99 wt % based on the total amount of the first layer. When the filler is included within the above range, desired or improved heat resistance, durability, oxidation resistance, and stability may be exhibited.

The first layer may have a thickness in a range of about 0.01 μm to 20 μm, and within this range, the thickness may be 1 μm to 10 μm, 1 μm to 5 μm, or 1 μm to 3 μm.

A ratio of the thickness of the first layer to the thickness of the porous substrate may range from about 0.05 to about 0.5, for example, from 0.05 to 0.4, from 0.05 to 0.3, or from 0.1 to 0.2. In the above range, the separator can exhibit desired or improved air permeability, heat resistance, and adhesiveness. Here, “thickness of the first layer” is a thickness of a single coating layer when the first layer is formed only on one surface of the porous substrate and is an overall thickness of two coating layers when the coating layer is formed on both surfaces of the porous substrate.

### Second Layer

The second layer is formed of or include a composition including a mixture of a polyvinylidene fluoride (PVdF)-based adhesive binder and a (meth)acrylic adhesive binder.

The second layer includes the (meth)acrylic adhesive binder together with the PVdF-based adhesive binder, and dry adhesion to a positive electrode and wet adhesion to a positive electrode may increase.

The PVdF-based adhesive binder is an organic-based adhesive binder.

The PVdF-based adhesive binder may include a vinylidene fluoride-derived unit. In one example embodiment, the PVdF-based adhesive binder may include a PVdF-based copolymer. For example, the PVdF-based adhesive binder may comprise a copolymer of vinylidene fluoride and hexafluoropropylene

The PVdF-based copolymer may include a range of about 1 mol % to about 10 mol %, for example, 1 mol % to 5 mol %, for example, 1, 2, 3, 4, 5, 6, 7, 8, 9, 10 mol %, 2 mol % to 5 mol %, of repeating units derived from hexafluoropropylene, based on a total of 100 mol % vinylidene fluoride and hexafluoropropylene.

The PVdF-based adhesive binder may have one or more of a carbonyl (C═O) functional group and a hydroxyl group (OH). The carbonyl (C═O) functional group and the hydroxyl group (OH) may further improve an adhesion function. A method for introducing a carbonyl functional group and a hydroxyl group into the copolymer may be a conventional method known to those skilled in the art.

The PVdF-based adhesive binder may include a unit derived from vinylidene fluoride, a unit derived from hexafluoropropylene, and a unit having one or more of a carbonyl (C═O) functional group and a hydroxyl group (OH).

The PVdF-based adhesive binder is a material having a high melting point (Tm) in a range of about 100° C. to about 200° C., and the particle shape thereof is maintained even after a thermal compression process, thereby contributing to securing air permeability of the separator after thermal compression. The PVdF-based adhesive binder may have a melting point of about 100° C. or higher, about 120° C. or higher, or about 130° C. or higher and about 200° C. or lower, about 180° C. or lower, about 170° C. or lower, or about 150° C. or lower, for example 100, 105, 110, 115, 120, 125, 130, 135, 140, 145, 150, 155, 160, 165, 170, 175, 180, 185, 190, 195, 200° C. Here, the melting point may be measured using, e.g., differential scanning calorimetry (DSC).

The PVdF-based adhesive binder may have a weight average molecular weight of about 100,000 g/mol or more, about 200,000 g/mol or more, about 300,000 g/mol or more, about 500,000 g/mol or more, about 1,500,000 g/mol or less, about 1,300,000 g/mol or less, or about 1,000,000 g/mol or less, for example, 100,000, 200,000, 300,000, 400,000, 500,000, 600,000, 700,000, 800,000, 900,000, 1,000,000, 1,100,000, 1,200,000, 1,300,000, 1,400,000, 1,500,000 g/mol. Here, the weight average molecular weight may be obtained as a polystyrene-converted value using, e.g., gel permeation chromatography.

The (meth)acrylic adhesive binder is or includes an organic-based adhesive binder.

The (meth)acrylic adhesive binder may have one or more of an amine group, a hydroxyl group, a carboxylic group, an amide group, and a cyano group as a functional group that can undergo a crosslinking reaction with the crosslinking agent.

According to one example embodiment, the (meth)acrylic adhesive binder may be or include a copolymer of a monomer mixture including one or more of a (meth)acrylic monomer having an amine group, a (meth)acrylic monomer having a hydroxyl group, a (meth)acrylic monomer having a carboxylic group (for example, (meth)acrylic acid), a (meth)acrylic monomer having an amide group, and a (meth)acrylic monomer having a cyano group (for example, (meth)acrylonitrile). According to one example embodiment, the monomer mixture may further include a (meth)acrylic monomer having an alkyl group, for example, a (meth)acrylic ester having a C1 to C5 alkyl group in the ester portion (for example, n-butyl (meth)acrylate).

The (meth)acrylic adhesive binder may have a glass transition temperature of about −10° C. or lower, for example, in a range of about −50 to about −10° C. Within this range, it may be possible to implement the effects of the separator.

The (meth)acrylic adhesive binder may have a weight average molecular weight in a range of about 500,000 g/mol to about 3,000,000 g/mol, for example, 500,000 g/mol to 2,000,000 g/mol or 500,000 g/mol to 1,500,000 g/mol, for example, 500,000, 600,000, 700,000, 800,000, 900,000, 1,000,000, 1,100,000, 1,200,000, 1,300,000, 1,400,000, 1,500,000, 1,600,000, 1,700,000, 1,800,000, 1,900,000, 2,000,000 g/mol. Within this range, it may be possible to implement the effects of the separator.

The (meth)acrylic adhesive binder may be included in an amount in a range of about 1 parts by weight to about 10 parts by weight based on 100 parts by weight of the PVdF-based adhesive binder. Within this range, dry adhesion to a positive electrode and wet adhesion to a positive electrode may increase. For example, the (meth)acrylic adhesive binder may be included in an amount of 3 parts by weight to 10 parts by weight, or 3 parts by weight to 7 parts by weight, based on 100 parts by weight of the PVdF-based adhesive binder. Within this range, a substrate binding force, dry adhesion to a positive electrode, and wet adhesion to a positive electrode may be further improved.

The second layer may have a thickness in a range of about 0.01 μm to about 20 μm, and within this range, the thickness may be 1 μm to 10 μm, 1 μm to 5 μm, or 1 μm to 3 μm.

### Porous Substrate

The porous substrate may have a plurality of pores, and may generally be or include a substrate used in an electrochemical device. Non-limiting examples of the porous substrate may be or include at least one of a polymer film formed of or including a polymer, or a copolymer or a mixture of two or more of polyolefin such as polyethylene, polypropylene, and the like, a polyester such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, polyphenylene oxide, a cyclic olefin copolymer, polyphenylene sulfide, polyethylene naphthalate, a glass fiber, Teflon, and polytetrafluoroethylene.

The porous substrate may be or include, for example, a polyolefin-based substrate including polyolefin, and the polyolefin-based substrate may contribute to improving safety of a battery due to the desired or improved shut-down function thereof. The polyolefin-based substrate may be or include, for example, at least one of a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin, or a copolymer of olefin and a non-olefin monomer.

The porous substrate may have a thickness in a range of about 1 μm to about 40 μm, for example 1 μm to 30 μm, 1 μm to 20 μm, or 5 μm to 15 μm.

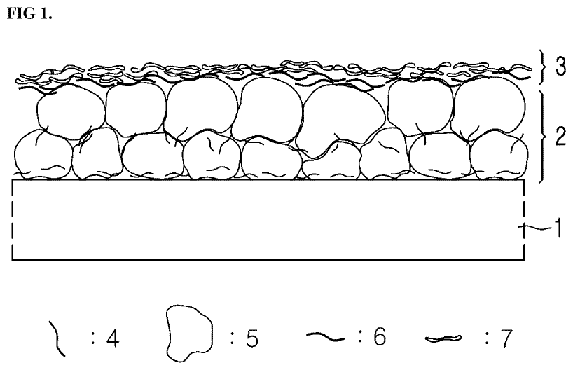

FIG. 1 is a cross-sectional view showing a separator for a rechargeable lithium battery according to one example embodiment.

Referring to FIG. 1, the separator for a rechargeable lithium battery includes a porous substrate 1, a first layer 2 and a second layer 3 located on one surface of the porous substrate 1. The first layer 2 includes a crosslinked product 4 of a binder and a crosslinking agent, and a filler 5. The second layer 3 includes a PVdF-based adhesive binder 6 and a (meth)acrylic adhesive binder 7, and the (meth)acrylic adhesive binder 7 is crosslinked to the crosslinking agent of a portion of the first layer 2 at an interface of the first layer 2 and the second layer 3.

Although not illustrated in FIG. 1, a separator in which the first layer 2 and the second layer 3 are each entirely located on one surface, or on both surfaces of the porous substrate 1 may also belong to the scope of the present disclosure.

### Method of Manufacturing Separator

The separator may be manufactured by preparing a porous substrate, a composition for forming a first layer, and a composition for forming a second layer; preparing a coating for the first layer by applying the composition for forming the first layer at a predetermined thickness on the porous substrate; preparing a coating for the second layer by applying the composition for forming the second layer on the coating for the first layer; humidifying the coating for the first layer and the coating for the second layer; and drying and aging.

The composition for forming the first layer may include the above-described binder, crosslinking agent, and filler. The composition may further include an aqueous solvent, for example, water.

The composition for forming the second layer may include the above-described PVdF-based adhesive binder and (meth)acrylic adhesive binder. The composition may further include acetone as an organic-based solvent, and may further include ethanol. Ethanol may cause the PVdF-based adhesive binder to move away from the coating for the first layer in the humidifying process.

The drying may be performed at a temperature in a range of about 40° C. to about 55° C., for example, about 50° C., for a duration in a range of about 30 seconds to about 10 minutes, for example, about 1 minute, in a drying furnace. Within these ranges, rolling or folding of an edge portion of the separator due to excessive drying of the coating for the first layer and the coating for the second layer is reduced or prevented, thereby reducing or preventing wrinkles during winding.

The aging may be performed at a higher temperature compared to the drying and for a longer period of time compared to the drying. In this case, the (meth)acrylic adhesive binder may be crosslinked to the crosslinking agent and the binder of the first layer, and a binding force at the interface between the first layer and the second layer may increase. For example, the aging may be performed at a temperature of about 50° C. or higher, for example, in a range of about 50° C. to about 70° C., for a duration of about 4 hours or more, for example, in a range of about 4 hours to about 12 hours. Within these ranges, effects due to aging may be obtained, and a problem in which the second layer is formed into a film, and released due to excessive aging, may not occur.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂ (PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol %, and less than or equal to about 99 mol %, based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in the form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed and used, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFBOP), lithium difluoro (oxalato) borate (LiDFOB), and lithium bis(oxalato) borate (LiBOB).

The rechargeable lithium battery may be classified into cylindrical, prismatic, pouch, or coin-type batteries, and the like depending on their shape.

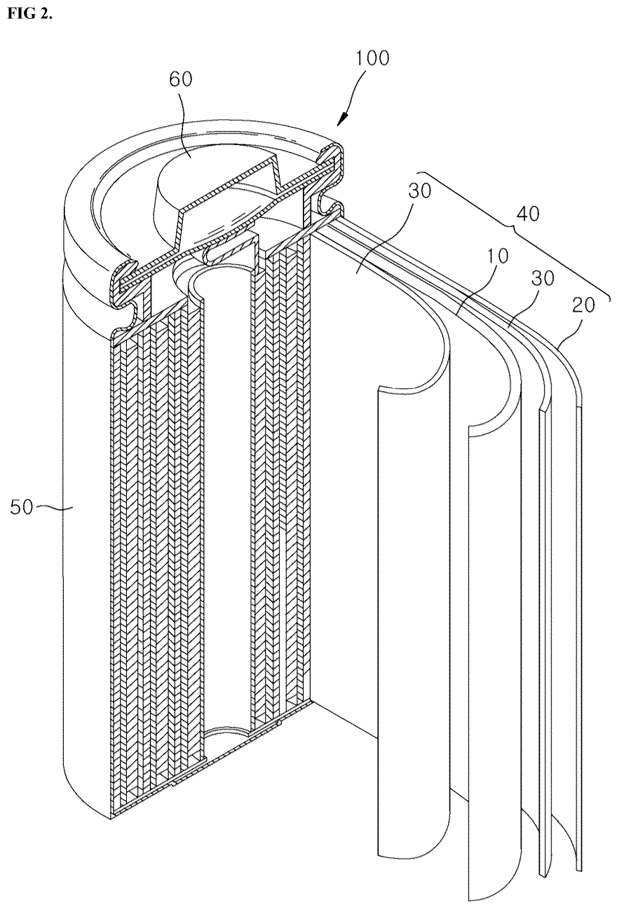

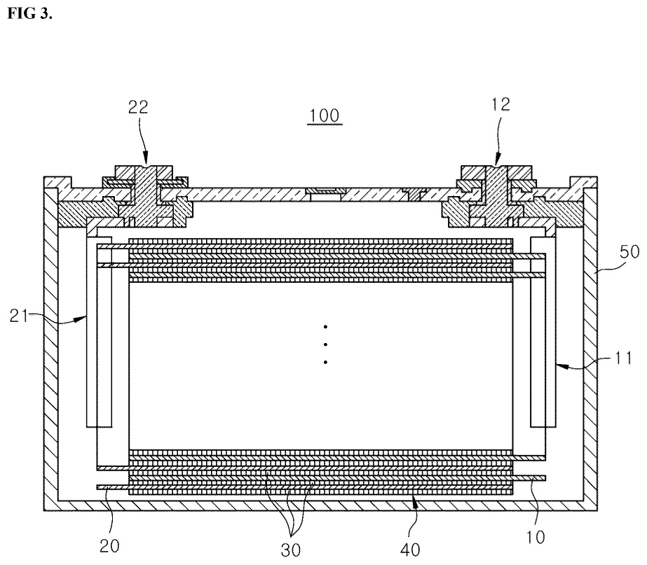

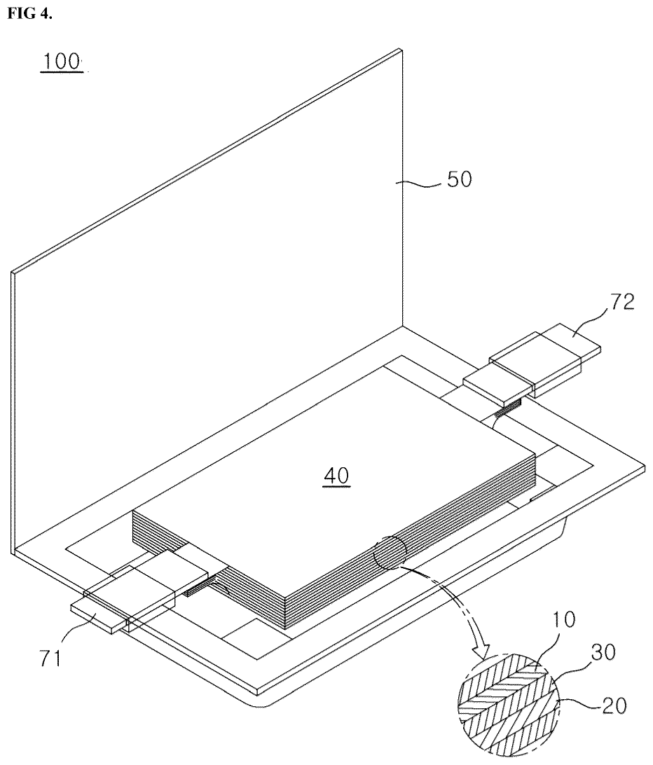

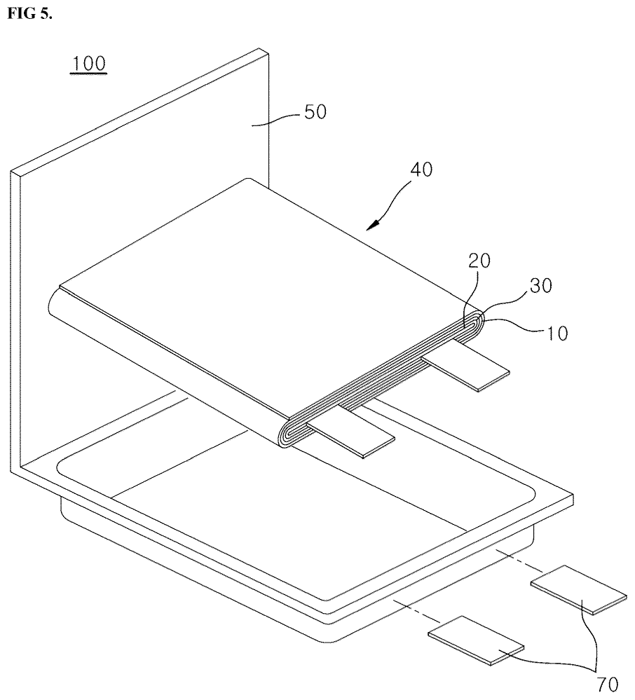

FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 4 and FIG. 5, the rechargeable lithium battery 100 may include an electrode tab 70 illustrated in FIG. 5, or for example, a positive electrode tab 71 and a negative electrode tab 72 illustrated in FIG. 4, the electrode tabs 70/71/72 forming an electric path for inducing the current formed in the electrode assembly 40 to the outside of the battery 100.

Hereinafter, examples and comparative examples of the present disclosure are described. However, the following examples are merely one example embodiment of the present disclosure, and the present disclosure is not limited to the following examples.

### Preparation Example 1

In a 10 L four-necked flask provided with a stirrer, a thermometer, and a cooling tube, a process of adding distilled water (6,361 g), acrylic acid (1.0 mol), acrylamide (8.5 mol), potassium persulfate (2.7 g, 0.01 mol), 2-acrylamido-2-methylpropanesulfonic acid (0.5 mol), and 5N lithium hydroxide solution (1.05 equivalents with respect to the total amount of 2-acrylamido-2-methylpropanesulfonic acid), then reducing an internal pressure to 10 mmHg using a diaphragm pump, and returning the internal pressure to a normal pressure using nitrogen was repeated three times.

The reaction was carried out for 12 hours while controlling the temperature of the reaction solution to be stable between 65° C. and 70° C. After cooling to room temperature, the pH of the reaction solution was adjusted to a range of 7 to 8 using a 25% ammonia solution.

In this way, poly(acrylic acid-co-acrylamide-co-2-acrylamido-2-methylpropanesulfonic acid) lithium salt was prepared. Here, a molar ratio of a structural unit derived from acrylic acid, a structural unit derived from acrylamide, and a structural unit derived from 2-acrylamido-2-methylpropanesulfonic acid was 10:85:5. 10 mL of the reaction solution (a reaction product) was taken to measure a non-volatile component, and the result was 9.5 wt % (a theoretical value: 10 wt %).

### Preparation Example 2

A binder was prepared in the same manner as in Preparation Example 1 except that, unlike in Preparation Example 1, a molar ratio of the structural unit derived from acrylamide and the structural unit derived from 2-acrylamido-2-methylpropanesulfonic acid was 85:15.

### Example 1

A dispersion was prepared by mixing an acrylic binder (10 wt % in distilled water) prepared in Preparation Example 1 and boehmite (particle diameter D100: 0.7 μm, particle diameter D50: 0.2 μm, sheet-shaped), adding the mixture to a water solvent, then milling the mixture for 30 minutes at 25° C. using a bead mill, dispersing the mixture, and adding water thereto until a total solid content became 20 wt %.

Citric acid was added as a crosslinking agent to the dispersion, and water was added thereto until a total solid content became 20 wt % to prepare a composition for forming a first layer.

In the composition for forming the first layer, the acrylic binder of Preparation Example 1 and boehmite were included at the acrylic binder:boehmite mass ratio of 1:20, and citric acid was included at 10 wt % with respect to the acrylic binder of Preparation Example 1.

100 parts by weight of a polyvinylidene fluoride (PVdF)-based binder and 5 parts by weight of a (meth)acrylic binder were mixed, acetone was added thereto, and a small amount of ethanol was added thereto to prepare a composition for forming a second layer.

As the PVdF-based binder, Solef 75130 (Solvay, melting point: 149.5° C., weight average molecular weight: 1,000,000 g/mol, including units derived from vinylidene fluoride and hexafluoropropylene, the unit derived from hexafluoropropylene included at a range of about 2 mol % to about 5 mol % of the entire units derived from vinylidene fluoride and hexafluoropropylene, having C═O group, and having an OH group) was used.

The (meth)acrylic binder was BM-520 (Zeon, weight average molecular weight: 1,400,000 g/mol, glass transition temperature: −20° C., a (meth)acrylic copolymer including units derived from acrylonitrile, acrylic acid, and alkyl acrylate).

The composition for forming the first layer was applied at a thickness of 1.0 μm on both surfaces of a polyethylene film (thickness: 5.5 μm, SK, air permeability: 120 sec/100 cc, puncture strength: 480 kgf) as a porous substrate using a bar coating method to prepare a coating layer for the first layer.

The prepared composition for forming the second layer was applied at a thickness of 0.5 μm on the coating layer for the first layer to form a coating layer for the second layer, and the coating layer for the second layer was humidified.

Then, the separator with the first layer and the second layer stacked thereon was dried at 50° C. for 1 minute and aged in an oven at 60° C. for 5 hours to manufacture the separator for a rechargeable lithium battery.

### Examples 2 to 4

A separator was manufactured in the same manner as in Example 1 except that the constitution of the composition for forming the second layer in Example 1 was changed as shown in Table 1 below (the content of the (meth)acrylic binder based on 100 parts by weight of the PVdF-based binder in the second layer was changed).

### Example 5

A separator was manufactured in the same manner as in Example 1 except that the binder of Preparation Example 2 was used instead of Preparation Example 1 in the composition for forming the first layer as shown in Table 1 below.

### Comparative Example 1

A separator was manufactured in the same manner as in Example 1 except that a crosslinking agent was not included in the composition for forming the first layer and aging was not performed.

### Comparative Example 2

A separator was manufactured in the same manner as in Example 1 except that a crosslinking agent was not included in the composition for forming the first layer, a (meth)acrylic adhesive binder was not included in the composition for forming the second layer, and aging was not performed.

### Comparative Example 3

A separator was manufactured in the same manner as in Example 1 except that a (meth)acrylic adhesive binder was not included in the composition for forming the second layer.

### Substrate Binding Force (Units: Gf/Mm)

The separators were cut into a width of 3 cm and a length of 8 cm to prepare samples. An adhesive tape (3M) was attached to a second layer surface of the sample in the machine direction of the separator, the surface to which the tape was attached and the substrate were separated by about 10 mm to 20 mm, a side of the substrate to which the tape was not attached was placed at an upper grip, the other side to which the tape was attached was placed at a lower grip, a distance between the grips was fixed to 20 mm, and then the sample was stretched and released. At this time, the release speed was 10 mm/min, and an average value of a force required to release 40 mm after the start of release was obtained by measuring the force three times. The substrate binding force may indicate that the (meth)acrylic adhesive binder in the second layer of the separator and the citric acid in the first layer are crosslinked at an interface of the first layer and the second layer.

### Dry Adhesion to Positive Electrode (Units: Gf/Mm)

The separators for rechargeable lithium batteries of the examples and comparative examples were cut into a size of 2.5 cm×8 cm to prepare samples.

A positive electrode active material slurry was prepared by mixing 97 wt % LiCoO₂, 1.5 wt % carbon black powder as a conductive additive, and 1.5 wt % PVdF, adding the mixture to an N-methyl-2-pyrrolidone solvent, and then stirring the mixture for 30 minutes using a mechanical stirrer. The slurry was applied on a 20 μm-thick aluminum current collector using a doctor blade, dried for 0.5 hours in a 100° C. hot air dryer, dried again for 4 hours under vacuum and 120° C. conditions, and roll-pressed to manufacture a positive electrode.

The separator was attached to a positive electrode (manufactured in the same manner as in the above manufacture of the battery) so that the second coating layer of the separator faces the positive electrode, the resulting assembly was inserted into a pouch, and the pouch was pressed under conditions of a pressure of 300 kgf/cm² to 500 kgf/cm², a temperature of 70° C. to 95° C., and a time of 30 second to 60 seconds, and then disassembled. After taking the separator and the positive electrode out of the pouch, the positive electrode and separator were spread out 180°, and the force required to detach the positive electrode from the separator was measured using a tension meter (Tinius Olsen, HT400).

### Wet Adhesion to Positive Electrode (Units: Gf/Mm)

The separators for rechargeable lithium batteries of the examples and comparative examples were cut into a size of 2.5 cm×8 cm to prepare samples.

A positive electrode active material slurry was prepared by mixing 97 wt % LiCoO₂, 1.5 wt % carbon black powder as a conductive additive, and 1.5 wt % PVdF, adding the mixture to an N-methyl-2-pyrrolidone solvent, and then stirring the mixture for 30 minutes using a mechanical stirrer. The slurry was applied on a 20 μm-thick aluminum current collector using a doctor blade, dried for 0.5 hours in a 100° C. hot air dryer, dried again for 4 hours under vacuum and 120° C. conditions, and roll-pressed to manufacture a positive electrode.

The separator was attached to a positive electrode (manufactured in the same manner as in the above manufacture of the battery) so that the second coating layer of the separator faces the positive electrode, the resulting assembly was inserted into a pouch, an electrolyte (1.3 M LiPF₆ in a 3/5/2 (volume ratio) mixed solvent of EC/EMC/DEC) was injected, and the pouch was allowed to stand for 12 hours, pressed under conditions of a pressure of 10 kgf/cm² to 20 kgf/cm², a temperature of 70° C. to 90° C., and a time of 5 second to 20 seconds, and then disassembled. After taking the separator and the positive electrode out of the pouch, the positive electrode and separator were spread out 180°, and the force required to detach the positive electrode from the separator was measured using a tension meter (Tinius Olsen, HT400).

TABLE 1

| | | | | | | | Adhesion | |
|---|---|---|---|---|---|---|---|---|
| | | | | | | | to | |
| | First layer | | Second layer | | | Substrate | positive | |
| | | Crosslinking | PVdF- | | | binding | electrode | |
| | Binder | agent | based | (Meth)acrylic | Aging | force | Dry | Wet |
| Example 1 | Preparation | Included | Included | 5 | Included | 1.2 | 1.2 | 1.4 |
| | Example 1 | | | | | | | |
| Example 2 | Preparation | Included | Included | 7 | Included | 1.4 | 0.9 | 1.1 |
| | Example 1 | | | | | | | |
| Example 3 | Preparation | Included | Included | 3 | Included | 1.1 | 1.0 | 1.0 |
| | Example 1 | | | | | | | |
| Example 4 | Preparation | Included | Included | 10 | Included | 1.5 | 0.9 | 0.9 |
| | Example 1 | | | | | | | |
| Example 5 | Preparation | Included | Included | 5 | Included | 1.2 | 1.2 | 1.3 |
| | Example 2 | | | | | | | |
| Comparative | Preparation | Not | Included | 5 | Not | 0.9 | 0.9 | 0.9 |
| Example 1 | Example 1 | included | | | Included | | | |
| Comparative | Preparation | Not | Included | — | Not | 0.9 | 0.8 | 0.8 |
| Example 2 | Example 1 | included | | | Included | | | |
| Comparative | Preparation | Included | Included | — | Included | 0.9 | 0.8 | 0.9 |
| Example 3 | Example 1 | | | | | | | |

As shown in Table 1 above, the separators for rechargeable lithium batteries of the Examples provided a high substrate binding force, high dry adhesion to a positive electrode, and high wet adhesion to a positive electrode. In addition, the separators of the Examples had a substrate binding force of 1.1 gf/mm or more, and it can be expected that the citric acid in the first layer and the (meth)acrylic adhesive binder in the second layer were crosslinked between the first layer and the second layer.

On the other hand, as shown in Table 1 above, as compared to the Examples, the substrate binding force, dry adhesion, and wet adhesion were all lower in Comparative Examples 1 and 2 in which the crosslinking agent was not included in the first layer, and Comparative Example 3 in which the (meth)acrylic adhesive binder was not included in the second layer.

A separator for a rechargeable lithium battery according to one example embodiment can improve the safety and lifespan of a battery by providing a high substrate binding force, high dry adhesion to a positive electrode, and high wet adhesion to a positive electrode.

A separator for a rechargeable lithium battery according to another example embodiment can improve the safety and lifespan of a battery by including a first layer and a second layer stacked on a porous substrate and providing a high interface binding force between the first layer and the second layer.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A separator for a rechargeable lithium battery, the separator comprising:
a porous substrate; and
a first layer and a second layer located on at least one surface of the porous substrate,
wherein the first layer comprises a composition including a binder, a crosslinking agent, and a filler,
the second layer comprises a composition including a mixture of a polyvinylidene fluoride (PVdF)-based adhesive binder and a (meth)acrylic adhesive binder, and
the (meth)acrylic adhesive binder is crosslinked to the binder of the first layer.

2. The separator of claim 1, wherein the (meth)acrylic adhesive binder is crosslinked to the binder of the first layer by the crosslinking agent at an interface of the first layer and the second layer.

3. The separator of claim 1, wherein the (meth)acrylic adhesive binder comprises a functional group that is configured to undergo a crosslinking reaction with the crosslinking agent.

4. The separator of claim 3, wherein the functional group that is able to undergo a crosslinking reaction with the crosslinking agent comprises one or more of an amine group, a hydroxyl group, a carboxylic group, an amide group, and a cyano group.

5. The separator of claim 1, wherein the PVdF-based adhesive binder comprises an organic-based adhesive binder.

6. The separator of claim 1, wherein the (meth)acrylic adhesive binder is included in an amount in a range of about 1 part by weight to about 10 parts by weight based on 100 parts by weight of the PVdF-based adhesive binder.

7. The separator of claim 1, wherein the (meth)acrylic adhesive binder has a glass transition temperature of about −10° C. or lower and a weight average molecular weight in a range of about 500,000 g/mol to about 3,000,000 g/mol.

8. The separator of claim 1, wherein the PVdF-based adhesive binder comprises:
a unit derived from vinylidene fluoride; and
a unit derived from hexafluoropropylene.

9. The separator of claim 1, wherein the PVdF-based adhesive binder comprises
a unit derived from vinylidene fluoride;
a unit derived from hexafluoropropylene; and
a unit having one or more of a carbonyl (C═O) functional group and a hydroxyl group (OH).

10. The separator of claim 1, wherein the PVdF-based adhesive binder has a melting point in a range of about 100° C. to about 200° C. and a weight average molecular weight of about 100,000 g/mol or more.

11. The separator of claim 1, wherein the crosslinking agent comprises citric acid.

12. The separator of claim 1, wherein the binder comprises a (meth)acrylic binder including a sulfonate group-containing structural unit.

13. The separator of claim 12, wherein the (meth)acrylic binder further comprises one or more of a structural unit derived from (meth)acrylate or (meth)acrylic acid, a cyano group-containing structural unit, and a structural unit derived from (meth)acrylamide.

14. The separator of claim 1, wherein the filler has a particle diameter D100 of about 1.0 μm or less.

15. A rechargeable lithium battery comprising:
the separator for a rechargeable lithium battery of claim 1;
a positive electrode; and
a negative electrode.
